(19) United States
(12) Patent Application Publication
(10) Pub. No.: US 2026/0050748 A1
(43) Pub. Date: Feb. 19, 2026

(54) Evaluating Output From Natural Language Processing System

(71) Applicant: Maplebear Inc., San Francisco, CA (US)

(72) Inventors: Riddhima Sejpal, Dublin, CA (US); Jatin Jain, Issaquah, WA (US); Lily Sierra, San Francisco, CA (US); Aomin Wu, Scarsdale, NY (US); Monta Shen, New York, NY (US)

(21) Appl. No.: 19/299,606

(22) Filed: Aug. 14, 2025

Related U.S. Application Data
(60) Provisional application No. 63/683,613, filed on Aug. 15, 2024.

(51) Int. Cl. G06F 40/40

(52) U.S. Cl. CPC G06F 40/40

(57) ABSTRACT

An online system interfaces with an LLM to evaluate chatbot responses to user inputs in a conversation. The online system divides the conversation into portions and prompts the LLM to separately evaluate the chatbot's latest response in each portion. These conversation portions may include different amounts of the conversation and may build off of one another such that some portions include inputs/responses of other portions. To evaluate a chatbot's latest response in a portion, the online system may prompt the LLM to generate a score for the chatbot's response in the portion according to a conversation criterion. The prompt may instruct the LLM to consider the context of previous inputs/responses in that potion to generate the score. The online system reviews the scores and determines if any of the scores are below corresponding criteria thresholds. If so, the online system may perform a remedial action for the entire conversation.

### CROSS REFERENCE TO RELATED APPLICATION

This application claims the benefit of U.S. Provisional Application No. 63/683,613, filed on Aug. 15, 2024, which is incorporated by reference herein in its entirety.

### BACKGROUND

Online systems may use a chatbot to generate automated responses to their users. To provide effective responses to users, a chatbot may use a large-language model (LLM) with instructions to generate responses based on certain objectives, goals, or restrictions. However, LLMs suffer from “hallucinations,” meaning that these models generate output that is inaccurate or that does not comply with restrictions set forth in the prompts to the LLMs. Therefore, LLMs are generally limited in their use to non-critical portions of an online system where hallucinations would not substantially impact the overall performance of the system, which dramatically limits the usability of LLMs in many important contexts.

### SUMMARY

In accordance with one or more aspects of the disclosure, an online system interfaces with an LLM to evaluate chatbot responses to user inputs in a conversation. The online system divides the conversation into portions and prompts the LLM to separately evaluate the chatbot's latest response in each portion. These conversation portions may include different amounts of the conversation and may build off of one another such that some portions include inputs/responses of other portions. For example, a first portion includes a first user input and a first chatbot response (responding to the first user input), and a second portion includes the first portion, a second user input subsequent to the first chatbot response, and a second chatbot response (responding to the second user input). To evaluate a chatbot's latest response in each portion, the online system may prompt the LLM to generate a score for the chatbot's response in the portion according to a conversation criterion (e.g., context awareness). The prompt may instruct the LLM to consider the context of previous inputs/responses in that potion to generate the score. The scores may be generated in parallel for the portions. The online system reviews the scores and determines if any of the scores are below corresponding criteria thresholds. If so, the online system may perform a remedial action, such as replacing the chatbot with another user by establishing a communication session between the user and the second user (assuming the conversation is still active).

Separately evaluating portions of a conversation between a chatbot and a user improves the technical field of natural language processing and evaluating automated output based on human-generated natural language. Specifically, evaluating portions simplifies the context, improves the evaluation accuracy (which addresses the challenge of context dilution for monolithic evaluations of conversations), and improves the reliability of evaluation systems. Furthermore, improved evaluations can be used to generate improved chatbot systems, for example, by training, retraining, or otherwise modifying chatbots based on the improved evaluations.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method of evaluating chatbot responses in a conversation between a chatbot and a user of an online system, in accordance with one or more embodiments.

FIG. 4 is a block diagram illustrating an evaluation of a chatbot's performance in a conversation, in accordance with one or more embodiments.

FIG. 5 is a diagram illustrating how a conversation is divided into portions for analysis by the online system, in accordance with one or more embodiments.

### DETAILED DESCRIPTION

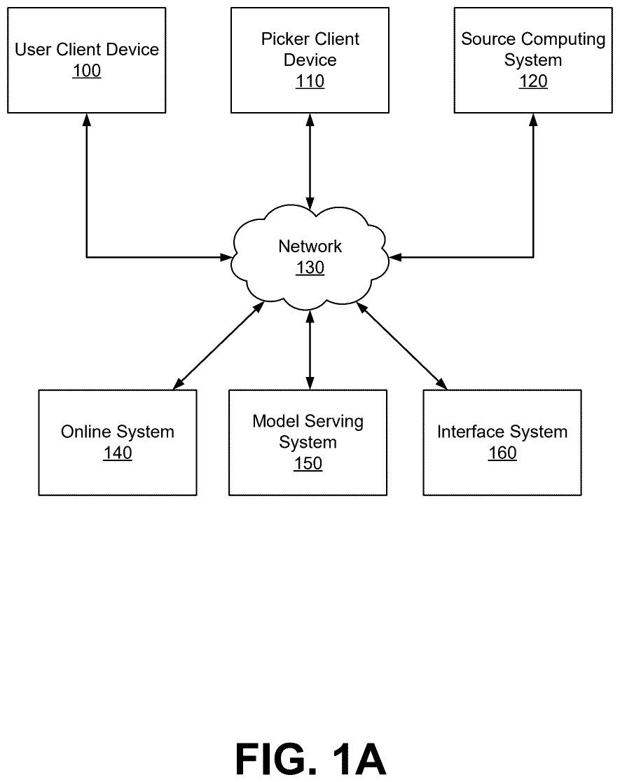

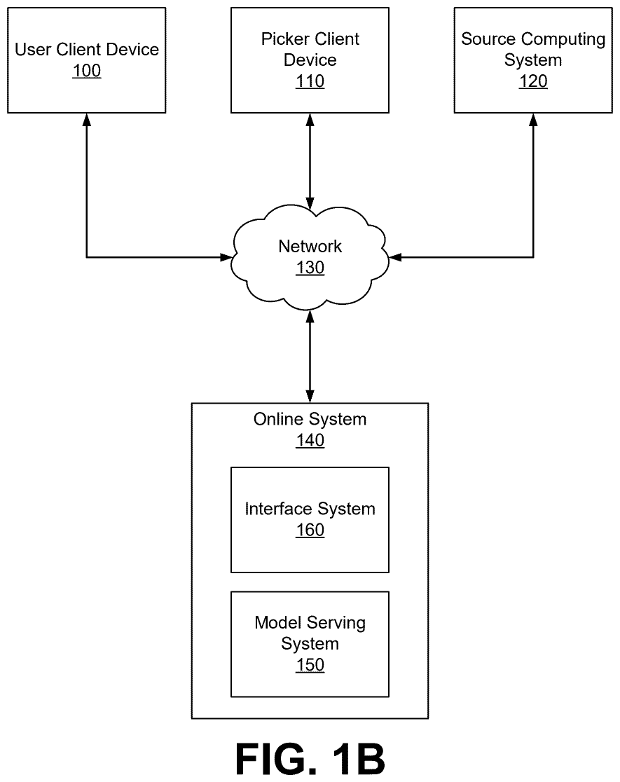

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding, or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

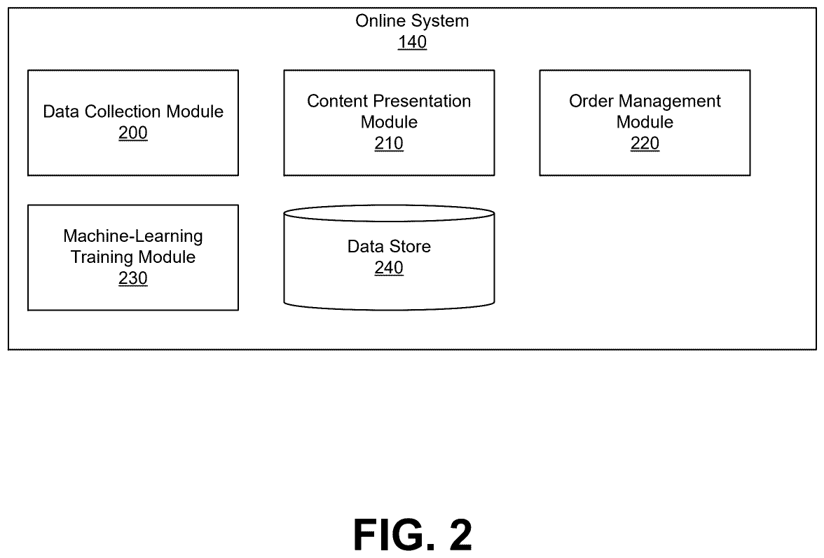

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

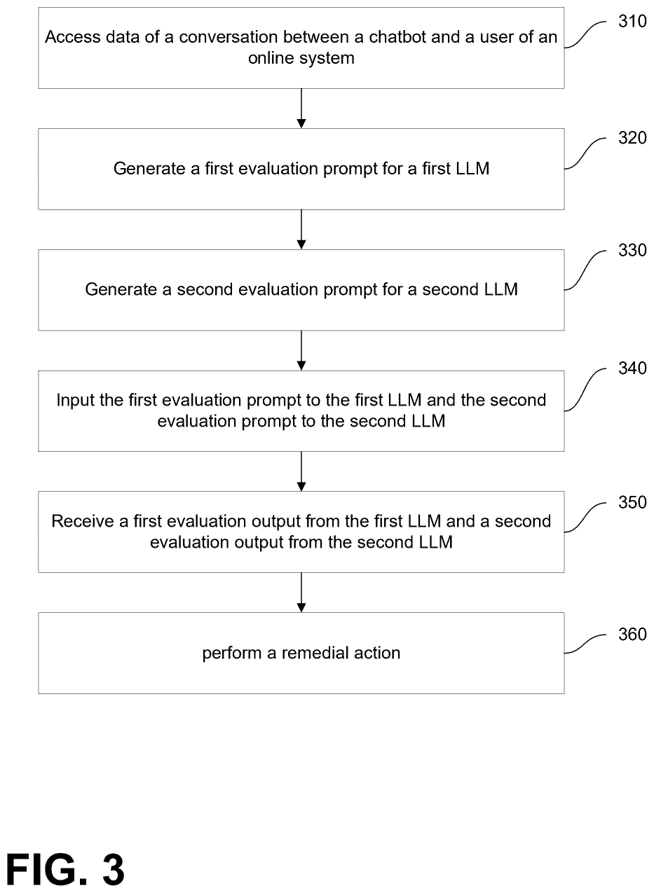

FIG. 3 is a flowchart for a method of evaluating chatbot responses in a conversation between a chatbot and a user of an online system (e.g., 140), in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140) or another system. Additionally, each of these steps may be performed automatically by the online system without human intervention.

At step 310, the online system accesses data of a conversation between a chatbot (e.g., an LLM-based chatbot or agent) and a user of an online system. The data includes user inputs from the user (e.g., provided via a client device) and chatbot responses from the chatbot (e.g., text inputs and responses). As used herein, an agent may refer to a system that interfaces with an LLM. For example, an agent may generate a prompt, input the prompt to an LLM, and receive corresponding output from the LLM to perform certain functionality.

At step 320, the online system generates (e.g., by an evaluator agent) a first evaluation prompt including data of a first portion of the conversation comprising a first user input and a first chatbot response responding to the first user input (e.g., the first portion doesn't include other user inputs or other chatbot responses). The first evaluation prompt also includes instructions for a first LLM to generate, in the context of the first user input, a score for the first chatbot response according to a criterion, where the score indicates the degree to which the first chatbot response satisfies the criterion. In some embodiments, the first evaluation prompt includes instructions to generate multiple scores according to multiple criteria (e.g., for different categories of evaluating customer service). Example criteria include relevance, context awareness, accuracy, clarity, tone, conciseness, business communication, resolution to the user's input, response efficiency, response compliance to brand standards, sentiment, and any combination thereof. The first evaluation prompt may include good and bad examples of chatbot responses and corresponding scores for those chatbot responses for one or more criteria.

At step 330, the online system generates (e.g., by the evaluator agent or another agent) a second evaluation prompt comprising data of a second portion the conversation comprising the first portion of the conversation, a second user input subsequent to the first chatbot response, and a second chatbot response responding to the second user input (e.g., the second portion doesn't include other user inputs or other chatbot responses). The second user input may be a response to the first chatbot response. The second evaluation prompt also includes instructions for a second LLM (the second LLM or a different LLM) to: generate, in the context of the second user input and the first portion of the conversation, a score for the second chatbot response according to the criterion (or a different criterion), where the score indicates the degree to which the second chatbot response satisfies the criterion. In some embodiments, the second evaluation prompt includes instructions to generate multiple scores according to multiple criteria. The second evaluation prompt may include good and bad examples of chatbot responses and corresponding scores for those chatbot responses for one or more criteria.

At step 340, the online system inputs the first evaluation prompt to the first LLM and inputs the second evaluation prompt to the second LLM.

At step 350, the online system receives a first evaluation output from the first LLM and a second evaluation output from the second LLM. The first evaluation output includes the score for the first chatbot response, and the second evaluation output includes the score for the second chatbot response (or the multiple scores if the first or second LLM were instructed to generate multiple scores). Among other advantages, breaking the conversations into smaller segments (e.g., the first portion and the second portion of the conversation) and performing evaluations on those smaller segments (e.g., generating scores) simplifies the conversation context and improves evaluation accuracy.

In some embodiments, (e.g., after step 350) the online system analyzes the outputs (e.g., and any corresponding information, such as the corresponding portion of the conversation or the evaluation prompt) to determine whether any of the evaluation outputs indicates a failed chatbot response. For example, the online system identifies one of the evaluation outputs indicates a failed chatbot response (in other words, one of the chatbot responses failed to satisfy one or more criteria). A failed chatbot response for an evaluation output indicates a score for the corresponding chatbot response is below a criterion score threshold for that criterion. If an evaluation output includes multiple scores for multiple criteria, the identification process by the online system may, for example, include determining whether each score meets a corresponding criterion score threshold, whether a total value of the scores meets a criteria threshold, whether an average of the scores meets an average criteria threshold, or some combination thereof.

At step 360, the online system (e.g., responsive to any of the evaluation outputs indicating a failed chatbot response) performs a remedial action (e.g., based on the failed chatbot response or to address the failed chatbot response). A remedial action can take many forms and may depend on the context of the conversation. The following describes example remedial actions. Note that any of the example remedial actions can be performed alone or in combination with any of the other example remedial actions. In a first example remedial action, the online system flags the conversation for further analysis. In another example remedial action, the online system trains a new chatbot based on the failed chatbot response (e.g., to replace the chatbot). In another example remedial action, if the conversation is still occurring (e.g., the online system performs steps of the method in real-time during a conversation) the remedial action may include establishing a communication session between the user and a second user (e.g., a customer service representative). Alternatively, the online system may establish a connection with a second chatbot that is more advanced than the chatbot (e.g., the second chatbot interfaces with a more advanced or improved LLM). In another example, the online system (e.g., the evaluator agent or another) feeds the evaluation output indicating a failed chatbot response back to the chatbot and prompts the chatbot to correct the error to improve the score for that criterion.

In another example of a remedial action, the online system performs prompt tuning on the chatbot based on the failed chatbot response. Prompt tuning is a parameter-efficient technique that improves the chatbot's outputs by introducing and optimizing a set of learnable prompt embeddings-referred to as “soft prompts”-which are prepended to the input tokens. These soft prompts may be updated via gradient descent based on the evaluation output, while the core model parameters remain unchanged. If an evaluation output indicates a failed chatbot response, the online system may use information about the failure-such as the specific criteria not met, the score, or the nature of the error-to inform the optimization objective, guiding the adjustment of the soft prompts to reduce similar failures in future responses. In some advanced implementations, related techniques such as prefix-tuning may be used, where trainable parameters are inserted not only at the input layer but also at each transformer layer, providing deeper integration of task-specific information.

In another example remedial action, the online system performs fine tuning on the chatbot based on the failed chatbot response. This process may involve collecting and analyzing one or more chatbot responses that did not meet specified criteria (e.g., as described by the evaluation output indicating a failed chatbot response) and then incorporating these failed responses-along with corrective annotations-into the training data of the LLM of the chatbot. The LLM is then fine-tuned using this augmented data set, allowing it to learn from its mistakes and improve future performance. This targeted fine-tuning helps the chatbot better satisfy evaluation criteria in subsequent interactions.

In some embodiments, the method, further includes generating (e.g., by the evaluator agent or another agent) a third evaluation prompt including data of a third portion of the conversation including the second portion of the conversation, a third user input subsequent to the second chatbot response, and a third chatbot response responding to the third user input (e.g., the third portion doesn't include other user inputs or other chatbot responses). The third user input may be a response to the second chatbot response. The third evaluation prompt also includes instructions for a third LLM (the first LLM, the second LLM, or a different LLM) to generate, in the context of the third user input and the second portion of the conversation, a score for the third chatbot response according to the criterion (or a different criterion), where the score indicates the degree to which the third chatbot response satisfies the criterion. The online system inputs the third evaluation prompt to the third LLM. The online system receives a third evaluation output from the third LLM including the score for the third chatbot. The remedial action (of step 360) may be performed responsive to the third evaluation output indicating a failed chatbot response (e.g., the score is below a threshold for the criterion). Note that the remedial action may be performed even if the first or second evaluation outputs do not indicate a failed chatbot response.

The online system may input two or more of the evaluation prompts to the corresponding LLMs in parallel such that the respective LLMs perform the evaluations in parallel. If a single

LLM is used, then the online system may input the two or more evaluation prompts to the LLM at the same time (e.g., combine the evaluation prompts into a single evaluation prompt).

In some embodiments, the method of FIG. 3 includes the online system evaluating one or more portions of the conversation using heuristic methods. This may improve the evaluation accuracy. Heuristics may be used for keyword-based checks because they provide better accuracy and consistency than LLM-based keyword-based checks. For example, the online system uses heuristics to check for the keyword “customer support” to flag improper references in self-awareness evaluations. Additional example heuristic checks include: checking for inappropriate language or profanity (e.g., that violates brand standards), detecting when the chatbot incorrectly claims to have access to real-time information (e.g., “I can see your current order status” when it cannot), identifying responses that contain placeholder text or template variables that were not properly filled in (e.g., “[CUSTOMER_NAME]” or “{{product_info}}”), or any combination thereof. If the output of a heuristic method indicates a failed chatbot response (e.g., one of the chatbot responses includes a word or phrase that it should not, such as “customer support”), the remedial action may be performed, even if other evaluation outputs do not indicate a failed chatbot response.

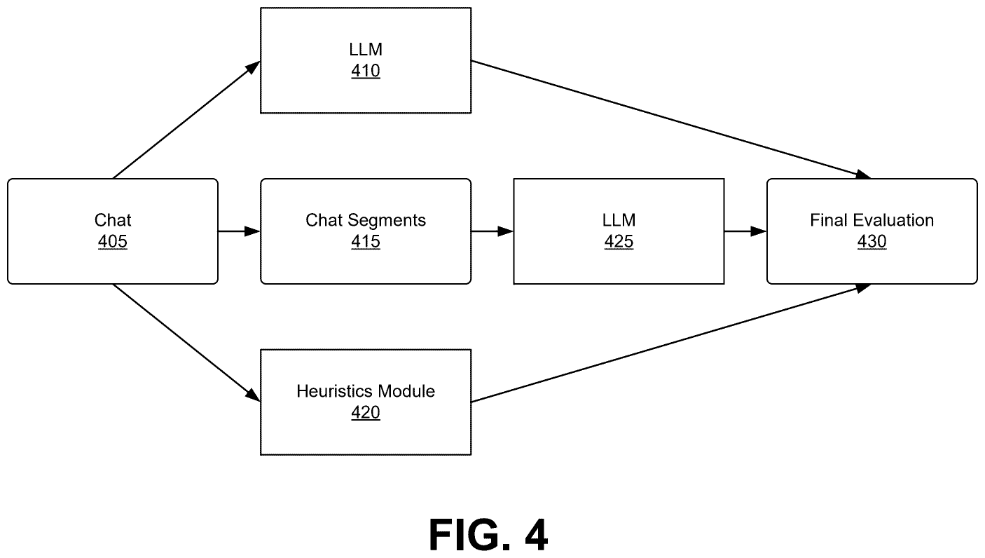

FIG. 4 is a block diagram illustrating an evaluation of a chatbot's performance in a conversation, according to one or more embodiments. Chat 405 refers to a conversation between the chatbot and a user (which include user inputs and chatbot responses). The chat 405 can be provided by the online system 140 to an LLM 410 for analysis. More specifically, a prompt is provided to the LLM 410, where the prompt includes the entire conversation and instructions to score the chatbot's responses in the conversation according to one or more criteria. Output from the LLM 410 (e.g., the score for the conversation) is provided by the online system 140 for a final evaluation 430 (performed by the online system 140).

The chat 405 is also provided by the online system 140 to a heuristics module 420 (which may be part of the online system 140) which performs one or more heuristic evaluations on the chatbot's responses in the chat 405. Output from the heuristics module 420 is also provided for the final evaluation 430.

The chat 405 is also divided, by the online system 140, into chat segments 415 (also referred to as portions) that include smaller portions of the conversation (instead of the entire conversation). For example, the first, second, and third portions described with respect to FIG. 3 are segments of a chat. Note that a segment may include data of another smaller segment (e.g., the second portion described with respect to the FIG. 3 includes the first portion). Said differently, segments may include progressively more data of a conversation.

The chat segments 415 are provided, by the online system 140, to the LLM 425 for analysis. More specifically, a prompt is provided to the LLM 425, where the prompt includes a chat segment and instructions to score the chatbot's one or more responses in the segment according to one or more criteria. The prompt may include multiple segments and instructions to score each segment separately. Alternatively, multiple prompts may be provided to the LLM 425 (e.g., a separate prompt for each chat segment). Outputs from the LLM 410 (e.g., the scores for the segments) are provided for the final evaluation 430.

The online system 140 performs the final evaluation 430. The final evaluation 430 is an evaluation of the chatbot's performance in the chat 405 based on the receive outputs from the LLM 410, the LLM 425, and the heuristics module 420 for the chat 405. In some embodiments, if any of the received outputs indicate a failure (e.g., any of the scores are below a corresponding criterion threshold or one of the heuristic checks indicates a failure), the online system 140 fails the chatbot's performance, which may trigger a remedial action by the online system 140.

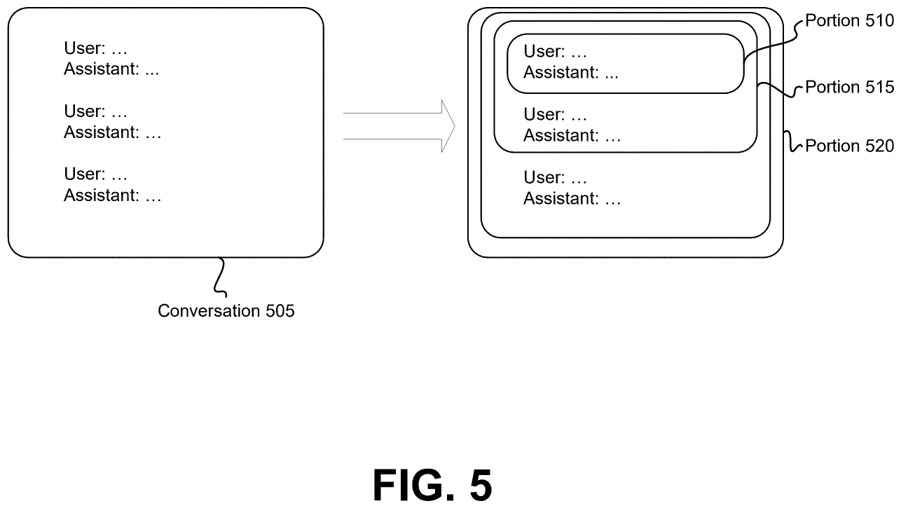

FIG. 5 is a diagram illustrating how a conversation 505 between a chatbot and a user is divided into portions for analysis by the online system 140, according to one or more embodiments. The conversation 505 represents the entire conversation, and the conversation 505 includes user inputs and chatbot responses. Note that the chatbot is labeled as “Assistant” and that the inputs/responses are signified by ellipses (the ellipses are not the actual inputs/responses). The online system 140 may interface with the LLM (via prompting) to analyze the conversation 505 to evaluate the chatbot's responses. For example, see the previous descriptions of chat 405 and LLM 410 with respect to FIG. 4.

The right side of FIG. 5 illustrates the conversation 505 being divided into portions. Portion 510 includes only the user's first input and the chatbot's response to that first input (e.g., portion 510 may be the first portion described with respect to FIG. 3). Portion 515 includes the portion 510 and the user's second input (which may be responding to the chatbot's first response), and the chatbot's response to that second input (portion 515 may be the second portion described with respect to FIG. 3). Portion 520 includes portion 515 and the user's third input (which may be responding to the chatbot's second response) and the chatbot's response to that third input (portion 520 may be the third portion described with respect to FIG. 3). In this example, portion 520 includes all of the inputs/responses of conversation 505.

The online system 140 may interface with an LLM (via prompting) to perform separate (e.g., independent) analyses on each portion of the conversation 505 to evaluate the chatbot's responses (e.g., to generate a score for the chatbot's latest response in each portion according to a criterion). Thus, for example, each chatbot response may be separately evaluated in light of (e.g., all) previous inputs/responses up to that point in the conversation. Performing separate evaluations on each chatbot response in light of previous inputs/responses as opposed to performing a single evaluation on all of the chatbot's responses at once may improve the LLM's evaluation accuracy, thus resulting in a better evaluation of the chatbot's performance.

To better illustrate why the online system 140 evaluates chat portions, consider a context awareness evaluation as an example (in other words, the chatbot's responses are evaluated according to the criterion of context awareness). To evaluate the entire conversation (e.g., 505), an example prompt is: “assess if each chatbot response properly factors in the information available up to that point in the conversation.” The success of this approach depends on the LLM correctly identifying the scope of the preceding context available to each response, which may be unreliable, especially in long and complex conversations. However, by breaking down a conversation into portions, the prompt can be more focused. For example: “analyze the information provided by the user so far and assess if the chatbot's answer correctly reflects that information.” This method reduces or eliminates the need for the LLM to implicitly determine the proper context associated with each response before evaluating them individually. It thus simplifies the process and helps boost evaluation accuracy. This approach can be considered a “divide and conquer” strategy, where a complex problem is broken down into more manageable parts. If any portion fails the check (e.g., a score for one of the responses was below a context awareness threshold), this indicates that one or more of the responses was not sufficiently context aware. In this situation, the online system 140 may perform a remedial action.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B arc true (or present) and C is false (or not present). Similarly, as another non-limiting example, the condition “A, B, or C” is satisfied when A is true (or present) and B and C are false (or not present).

What is claimed is:

1. A method performed at a computer system comprising a processor and a computer-readable medium, the method comprising:
accessing data of a conversation between a chatbot and a user of an online system, the data including user inputs from the user and chatbot responses from the chatbot;
generating a first evaluation prompt comprising (a) data of a first portion of the conversation comprising a first user input and a first chatbot response responding to the first user input and (b) instructions for a first LLM (large language model) to:
generate, in the context of the first user input, a score for the first chatbot response according a criterion, the score indicating the degree to which the first chatbot response satisfies the criterion;
generating a second evaluation prompt comprising (a) data of a second portion the conversation comprising the first portion of the conversation, a second user input subsequent to the first chatbot response, and a second chatbot response responding to the second user input and (b) instructions for a second LLM to:
generate, in the context of the second user input and the first portion of the conversation, a score for the second chatbot response according to the criterion, the score indicating the degree to which the second chatbot response satisfies the criterion;
inputting the first evaluation prompt to the first LLM and the second evaluation prompt to the second LLM;
receiving a first evaluation output from the first LLM and a second evaluation output from the second LLM, the first evaluation output including the score for the first chatbot response and the second evaluation output including the score for the second chatbot response; and
responsive to one of the evaluation outputs indicating a failed chatbot response, performing a remedial action.

2. The method of claim 1, further comprising:
generating a third evaluation prompt comprising (a) data of a third portion of the conversation comprising the second portion of the conversation, a third user input subsequent to the second chatbot response, and a third chatbot response responding to the third user input and (b) instructions for a third LLM to:
generate, in the context of the third user input and the second portion of the conversation, a score for the third chatbot response according to the criterion, the score indicating the degree to which the third chatbot response satisfies the criterion;
inputting the third evaluation prompt to the third LLM; and
receiving a third evaluation output from the third LLM including the score for the third chatbot,
wherein the remedial action is performed responsive to the third evaluation output indicating a failed chatbot response.

3. The method of claim 2, wherein the second LLM is the first LLM; and the third LLM is the first LLM.

4. The method of claim 2, wherein inputting the first evaluation prompt to the first LLM, the second evaluation prompt to the second LLM, and the third evaluation prompt to the third LLM comprises inputting the evaluation prompts in parallel to the respective LLMs such that the respective LLMs perform the evaluations in parallel.

5. The method of claim 2, wherein:
the second user input is a response to the first chatbot response; and
the third user input is a response to the second chatbot response.

6. The method of claim 1, further comprising:
identifying the one of the evaluation outputs indicates the failed chatbot response, wherein a failed chatbot response indicates a score for a chatbot response is below a criterion score threshold for the criterion.

7. The method of claim 1, wherein performing the remedial action comprises establishing a communication session between the user and a second user.

8. The method of claim 1, wherein performing the remedial action comprises updating learnable prompt embeddings of an LLM of the chatbot based on the one of the evaluation outputs indicating a failed chatbot response.

9. The method of claim 1, wherein performing the remedial action comprises updating parameters of an LLM of the chatbot by retraining the LLM based on the one of the evaluation outputs indicating a failed chatbot response.

10. The method of claim 1, wherein performing the remedial action comprises training a new chatbot based on the failed chatbot response.

11. One or more non-transitory computer-readable storage mediums storing instructions that, when executed by a computer system, causes the computer system to perform operations comprising:
accessing data of a conversation between a chatbot and a user of an online system, the data including user inputs from the user and chatbot responses from the chatbot;
generating a first evaluation prompt comprising (a) data of a first portion of the conversation comprising a first user input and a first chatbot response responding to the first user input and (b) instructions for a first LLM (large language model) to:
generate, in the context of the first user input, a score for the first chatbot response according a criterion, the score indicating the degree to which the first chatbot response satisfies the criterion;
generating a second evaluation prompt comprising (a) data of a second portion the conversation comprising the first portion of the conversation, a second user input subsequent to the first chatbot response, and a second chatbot response responding to the second user input and (b) instructions for a second LLM to:
generate, in the context of the second user input and the first portion of the conversation, a score for the second chatbot response according to the criterion, the score indicating the degree to which the second chatbot response satisfies the criterion;
inputting the first evaluation prompt to the first LLM and the second evaluation prompt to the second LLM;
receiving a first evaluation output from the first LLM and a second evaluation output from the second LLM, the first evaluation output including the score for the first chatbot response and the second evaluation output including the score for the second chatbot response; and
responsive to one of the evaluation outputs indicating a failed chatbot response, performing a remedial action.

12. The one or more non-transitory computer-readable storage mediums of claim 11, further comprising:
generating a third evaluation prompt comprising (a) data of a third portion of the conversation comprising the second portion of the conversation, a third user input subsequent to the second chatbot response, and a third chatbot response responding to the third user input and (b) instructions for a third LLM to:
generate, in the context of the third user input and the second portion of the conversation, a score for the third chatbot response according to the criterion, the score indicating the degree to which the third chatbot response satisfies the criterion;
inputting the third evaluation prompt to the third LLM; and
receiving a third evaluation output from the third LLM including the score for the third chatbot,
wherein the remedial action is performed responsive to the third evaluation output indicating a failed chatbot response.

13. The one or more non-transitory computer-readable storage mediums of claim 12, wherein the second LLM is the first LLM; and the third LLM is the first LLM.

14. The one or more non-transitory computer-readable storage mediums of claim 12, wherein inputting the first evaluation prompt to the first LLM, the second evaluation prompt to the second LLM, and the third evaluation prompt to the third LLM comprises inputting the evaluation prompts in parallel to the respective LLMs such that the respective LLMs perform the evaluations in parallel.

15. The one or more non-transitory computer-readable storage mediums of claim 12,
wherein:
the second user input is a response to the first chatbot response; and
the third user input is a response to the second chatbot response.

16. The one or more non-transitory computer-readable storage mediums of claim 11, further comprising:
identifying the one of the evaluation outputs indicates the failed chatbot response, wherein a failed chatbot response indicates a score for a chatbot response is below a criterion score threshold for the criterion.

17. The one or more non-transitory computer-readable storage mediums of claim 11, wherein performing the remedial action comprises establishing a communication session between the user and a second user.

18. The one or more non-transitory computer-readable storage mediums of claim 11, wherein performing the remedial action comprises updating learnable prompt embeddings of an LLM of the chatbot based on the one of the evaluation outputs indicating a failed chatbot response.

19. The one or more non-transitory computer-readable storage mediums of claim 11, wherein performing the remedial action comprises at least one of:
updating parameters of an LLM of the chatbot by retraining the LLM based on the one of the evaluation outputs indicating the failed chatbot response; or
training a new chatbot based on the failed chatbot response.

20. A computer system comprising a set of one or more processors and a computer-readable storage medium storing instructions that, when executed by the set of processors, causes the set of processors to perform operations comprising:
accessing data of a conversation between a chatbot and a user of an online system, the data including user inputs from the user and chatbot responses from the chatbot;
generating a first evaluation prompt comprising (a) data of a first portion of the conversation comprising a first user input and a first chatbot response responding to the first user input and (b) instructions for a first LLM (large language model) to:
generate, in the context of the first user input, a score for the first chatbot response according a criterion, the score indicating the degree to which the first chatbot response satisfies the criterion;
generating a second evaluation prompt comprising (a) data of a second portion the conversation comprising the first portion of the conversation, a second user input subsequent to the first chatbot response, and a second chatbot response responding to the second user input and (b) instructions for a second LLM to:
generate, in the context of the second user input and the first portion of the conversation, a score for the second chatbot response according to the criterion, the score indicating the degree to which the second chatbot response satisfies the criterion;
inputting the first evaluation prompt to the first LLM and the second evaluation prompt to the second LLM;
receiving a first evaluation output from the first LLM and a second evaluation output from the second LLM, the first evaluation output including the score for the first chatbot response and the second evaluation output including the score for the second chatbot response; and
responsive to one of the evaluation outputs indicating a failed chatbot response, performing a remedial action.
